(19) United States
(12) Patent Application Publication
(10) Pub. No.: US 2005/0134178 A1
(43) Pub. Date: Jun. 23, 2005

(54) Plasma display panel

(76) Inventor: Ki-Dong Kim, Suwon-si (KR)

Correspondence Address: CHRISTIE, PARKER & HALE, LLP, PO BOX 7068, PASADENA, CA, 91109-7068, US

(21) Appl. No.: 10/969,345

(22) Filed: Oct. 19, 2004

(30) Foreign Application Priority Data
Oct. 21, 2003 (KR) 10-2003-0073520

(51) Int. Cl. H01J 17/49

(52) U.S. Cl. 313/587; 313/586

(57) ABSTRACT

The plasma display panel includes a substrate, a plurality of electrodes formed on the substrate, a dielectric layer covering the plurality of electrodes, and a protective layer covering the dielectric layer. The protective layer comprises MgO with 0.1 to 3 mol % of ZrO₂ added.

### CROSS-REFERENCE TO RELATED APPLICATIONS

This application claims priority to and the benefit of Korean Patent Application No. 10-2003-0073520 filed on Oct. 21, 2003 in the Korean Intellectual Property Office, the entire content of which is incorporated herein by reference.

### BACKGROUND OF THE INVENTION

(a) Field of the Invention

The present invention relates to a plasma display panel, and in particular, to a protective layer for a plasma display panel with improved performance characteristics.

(b) Description of Related Art

Generally, a plasma display panel (PDP) is a display device which displays characters or graphics. In operation, a predetermined voltage is applied across two electrodes placed within the discharge space of the plasma display panel with the resulting plasma discharge generating ultraviolet light. The ultraviolet light excites a phosphor film to generate visible light of a predetermined pattern, thereby displaying the desired images.

Plasma display panels are generally classified as an AC type, a DC type or a hybrid type. FIG. 10 is an exploded perspective view of a discharge cell of a common AC type plasma display panel. As shown in FIG. 10, the plasma display panel 100 includes a front (or rear) substrate 111, a plurality of address electrodes 115 formed on the bottom substrate 111, a dielectric layer 119 formed on the substrate 111 with the address electrodes 115, a plurality of barrier ribs 123 formed on the dielectric layer 119 to maintain the discharge distance while preventing the inter-cell cross talk, and a phosphor layer 125 formed on the barrier ribs 123.

A plurality of discharge sustain electrodes 117 are formed on a front substrate 113 facing the rear substrate 111 such that they are spaced apart from the address electrodes 115 by a predetermined distance while perpendicular thereto. A dielectric layer 121 and a protective layer 127 sequentially cover the discharge sustain electrodes 117. The protective layer 127 is typically formed from MgO, which is transparent such that visible light can pass through. It is known that such a MgO-based protective layer 127 can protect the dielectric layer 121 while maintaining excellent electron emission capacity. Recently, other materials have been also investigated for use in forming a protective layer 127.

The MgO protective layer is provided at a thickness of 3,000 to 7,000 Å and protects the dielectric layer from ion bombardment, and emits secondary electrons to lower the discharge voltage. The MgO protective layer is formed using various techniques such as sputtering, electron beam deposition, ion beam assisted deposition (IBAD), chemical vapor deposition (CVD), and sol-gel, and recently, the ion plating technique.

With the electron beam deposition technique, the electron beams accelerated by the electromagnetic fields collide against the MgO depositing material to heat and vaporize it, thereby forming a MgO protective layer. Compared to the electron beam deposition technique, the sputtering technique makes the resulting protective layer denser and provides improved crystal alignment, but involves high production costs. With the sol-gel technique, the MgO protective layer is formed with a liquid phase.

As an alternative to the various techniques of forming the MgO protective layer, the ion plating technique has been recently introduced with the steps of ionizing evaporated particles and forming a layer. The ion plating technique is similar to the sputtering technique in that it gives the properties of adherence and crystallinity to the resulting MgO protective layer, but differs from the latter in that it provides an advantage in making the deposition at high speed on the order of 8 nm/s.

The MgO material may be formed with a single crystalline phase or a sintered one. When the single crystalline MgO material is melted to make the deposition, it is difficult to control the concentration of dopants because the solid solution is limited by the cooling speeds. Therefore, the MgO protective layer is often formed by using the sintered MgO material where the relevant dopants are quantitatively added, based on the ion plating technique.

As the MgO protective layer contacts the discharge gas, the amount of MgO and its layer formation conditions may greatly influence the discharge characteristics and the performance characteristics of the MgO protective layer. Accordingly, it is desired to find an optimum material composition for the protective layer, which is well adapted for obtaining the desired performance characteristics.

### SUMMARY OF THE INVENTION

The present invention improves the performance characteristics of a MgO protective layer for a plasma display panel.

In one embodiment of the present invention, an optimum material composition for a protective layer of a plasma display panel is provided. A plasma display panel including the improved material composition can have the following features.

The plasma display panel includes a substrate, a plurality of electrodes formed on the substrate, a dielectric layer covering the plurality of electrodes, and a protective layer covering the dielectric layer. The protective layer comprises MgO with 0.1 to 3 mol % of ZrO₂, and more preferably, 1.8 to 2.2 mol % of ZrO₂.

The ZrO₂ is preferably provided as a solid solution of Zr in MgO. Such a protective layer has a transmissivity of 90% or more, and a thickness of 600 nm or more. The protective layer has a refractive index of 1.45 to 1.74 while bearing a columnar crystal structure. The protective layer may be manufactured from a MgO pellet comprising MgO with 0.1 to 3 mol % of ZrO₂.

### BRIEF DESCRIPTION OF THE DRAWINGS

FIG. 1 is a perspective view of an front panel portion for a plasma display panel according to an embodiment of the present invention.

FIG. 2 is a graph illustrating the deposition speed of a MgO—ZrO₂ protective layer as a function of the amount of addition of ZrO₂.

FIG. 3 illustrates the X-ray diffraction analysis result of a MgO—ZrO₂ protective layer.

FIG. 4 is a graph illustrating the refractive index of a MgO—ZrO₂ protective layer as a function of the amount of addition of ZrO₂.

FIG. 5 illustrates the packing density of a MgO—ZrO₂ protective layer as a function of the amount of addition of ZrO₂.

FIG. 6 is a graph illustrating the surface roughness of a MgO—ZrO₂ protective layer as a function of the amount of addition of ZrO₂.

FIG. 7 illustrates the secondary electron discharge coefficient as a function of the accelerating voltage per the amount of addition of ZrO₂.

FIG. 8 illustrates the discharge initiating voltage Vf and the discharge sustain voltage Vs of a MgO—ZrO₂ protective layer as a function of the amount of addition of ZrO₂.

FIG. 9 illustrates the secondary electron discharge coefficient of the non-treated MgO—ZrO₂ protective layer (the amount of addition of ZrO₂: 2 mol %) directly after the deposition and that of the heat-treated MgO—ZrO₂ protective layer (the amount of addition of ZrO₂: 2 mol %).

FIG. 10 is an exploded perspective view of a discharge cell of a common AC type plasma display panel.

### DETAILED DESCRIPTION OF PREFERRED EMBODIMENTS

An exemplary embodiment of the present invention will now be described in detail with reference to the accompanying drawings.

With a common plasma display panel, a protective layer covers the surface of a dielectric layer to protect it from the ion bombardment of the discharge gas during the discharging.

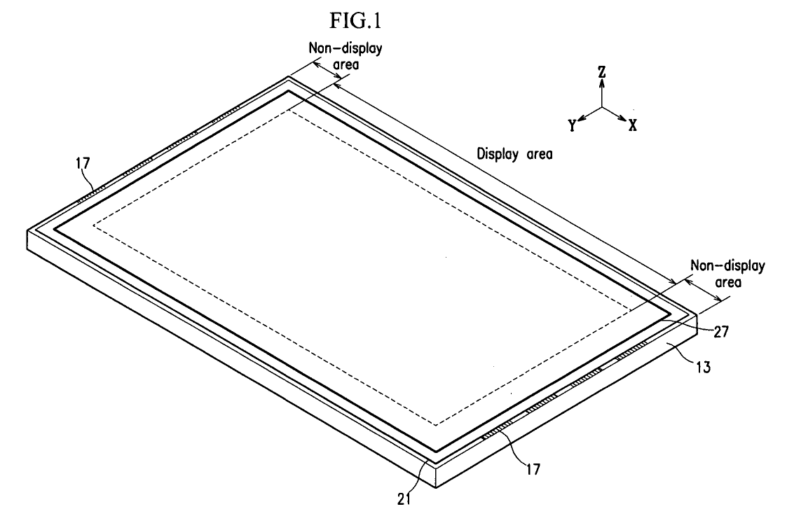

FIG. 1 is a perspective view of a plasma display panel according to an embodiment of the present invention. In the drawing, only the front panel portion of the plasma display panel according to the embodiment is separately illustrated.

As shown in FIG. 1, a plurality of first electrodes 17, a dielectric layer 21 and a protective layer 27 are sequentially formed on a substrate 13. Although not shown in FIG. 1, a plurality of second electrodes are formed on another substrate facing the substrate 13 while running perpendicular to the first electrodes 17, and a dielectric layer covers the second electrodes. Barrier ribs are formed on the dielectric layer, and phosphor films are formed between the barrier ribs. In this way, the rear panel portion of the plasma display panel is made.

The front and the rear panel portions of the plasma display panel are coated with a frit in their peripheries, and sealed to each other via the frit. A discharge gas such as Ne and Xe is injected into the inner space of the panel, thereby completing the plasma display panel.

With the plasma display panel according to an embodiment of the present invention, the address discharging is made among the electrodes by applying driving voltages to the electrodes from wall charges at the dielectric layer. With the discharge cells selected by the address discharging, the sustain discharge is made among the electrodes by AC signals alternately supplied to a pair of electrodes formed on the front panel portion. Accordingly, the discharge gas filled within the discharge space for forming the discharge cell is excited, thereby generating ultraviolet light. The ultraviolet light excites the phosphors to generate visible light, thereby displaying the desired images.

The protective layer is commonly formed with MgO because it has excellent sputtering-resisting characteristics, and a high secondary electron discharge coefficient.

The MgO protective layer is formed using the techniques such as sputtering, electron beam deposition, ion beam assisted deposition (IBAD), chemical vapor deposition (CVD), sol-gel, and recently, the ion plating technique.

The MgO material may be formed with a single-crystalline phase or a sintered one. However, when single-crystalline MgO material is melted to make a deposition, it is difficult to control the concentration of dopants as previously mentioned. Therefore, the MgO protective layer is preferably formed by using sintered MgO material where the relevant dopants are quantitatively added, based on the ion plating technique.

A pellet is formed and sintered to make the deposition of the MgO protective layer. As the decomposition speed of the pellet varies depending upon the size and form of the pellet, the size and form of the pellet can be used to control the speed of deposition of the protective layer. Therefore, various attempts have been made to optimize the size and form of the pellet.

As the MgO protective layer contacts the discharge gas, the contents and characteristics thereof greatly affect the discharge characteristic. The performance characteristics of the MgO protective layer largely depend upon the contents and the deposition conditions thereof.

It has been discovered that the properties of the protective layer can be improved when ZrO₂ is added to MgO that is used to form a protective layer for the plasma display panel. Such a layer can be formed from pellets in which MgO and ZrO₂ are mixed.

The ZrO₂ is added to MgO as a solid solution. The amount of ZrO₂ added can be up to 3 mol % at which point the solid solution limitation is reached. In order to achieve the desired characteristics, it is preferred that 0.1 mol % or more of ZrO₂ should be added.

Accordingly, the preferred amount of ZrO₂ is from 0.1 to 3 mol %, and more preferably, from 1.8 to 2.2 mol %.

When ZrO₂ is added to MgO, the deposition speed is reduced. This is because when the MgO—ZrO₂ layer is deposited, the vapor pressure of ZrO₂ is considerably lower than that of MgO. As the amount of addition of ZrO₂ is increased, the deposition speed of the MgO—ZrO₂ layer is further reduced.

Furthermore, when ZrO₂ is added to MgO, the X-ray diffraction peak is shifted to the lower value of 2θ as the amount of ZrO₂ increases. This means that the lattice constant of the MgO—ZrO₂ layer is increased. This is because Zr has a large ion radius when solid-soluted in MgO. According to the X-ray diffraction peak, the addition of ZrO₂ does not adversely affect the crystallinity and alignment of the MgO layer.

The refractive index of the MgO—ZrO₂ protective layer increases as the amount of ZrO₂ is increased. This is because the refractive index of ZrO₂ is larger than that of MgO. For a MgO protective layer where the amount of ZrO₂ is from 0.1 to 3 mol %, the refractive index thereof is 1.45 to 1.74.

It has also been discovered that the packing density of a MgO—ZrO₂ protective layer is higher than that of a pure MgO layer. It is reported that as the packing density of the protective layer increases, the plasma corrosion resistant characteristic is enhanced. Therefore, in the case of a MgO—ZrO₂ protective layer, the plasma corrosion resistant properties are enhanced, and the resulting plasma display panel exhibits a longer life span.

It has also been discovered that where the surface roughness of the protective layer is high, the transmissivity of visible light is inhibited due to light scattering. Therefore, it is preferable to use a protective layer with a lower surface roughness.

When ZrO₂ is added to the MgO layer, the surface roughness thereof decreases until the amount of ZrO₂ added reaches 2 mol %, at which point the surface roughness increases. In the inventive MgO protective layer where the amount of addition of ZrO₂ is from 0.1 to 3 mol %, the surface roughness (RMS average value) thereof is 15 nm or less. That is, the inventive MgO—ZrO₂ layer has an excellent surface roughness.

It has still further been discovered that the inclusion of ZrO₂ greatly improves the optical properties. Therefore, even though ZrO₂ is added to the MgO layer, the transmissivity thereof varies little. Accordingly, in the case of the MgO protective layer where the amount of addition of ZrO₂ is from 0.1 to 3 mol %, the transmissivity thereof reaches 90% or more.

When ZrO₂ is added to the MgO layer, the secondary electron discharge coefficient thereof is increased compared to a pure MgO layer. For example, when the amount of addition of ZrO₂ is 2 mol %, the secondary electron discharge coefficient of the MgO—ZrO₂ protective layer is from 0.024 to 0.089 compared to that of a pure MgO layer being from 0.02 to 0.045. When the secondary electron discharge coefficient is increased, the discharge voltage is decreased, thereby enhancing the device driving and discharging characteristics at lower voltages.

It has further been discovered that when ZrO₂ is added to the MgO layer, the discharge initiating voltage (Vf) and the discharge sustain voltage (Vs) are reduced compared to the pure MgO layer. For example, the pure MgO layer involves the discharge initiating voltage of 187 V and the discharge sustain voltage of 155 V, whereas when 2 mol % of ZrO₂ is added to the MgO layer, the discharge initiating voltage thereof is 167 V, and the discharge sustain voltage is 137 V. That is, the voltage characteristic of the protective layer is enhanced by the addition of ZrO₂.

When ZrO₂ is added to the MgO layer, the performance characteristics of the protective layer are also enhanced. Furthermore, when the MgO—ZrO₂ layer is heat-treated, the moisture-resistance is improved, thereby further enhancing the layer's properties. While the specific temperature, time and pressure for the heat treatment step are not essential, it is preferable that the heat treatment be carried out under vacuum at 100° C. or more for 20 or more minutes.

When the MgO—ZrO₂ solution has undergone heat treatment, the secondary electron discharge coefficient of the MgO—ZrO₂ protective layer is increased, but the discharge initiating voltage and the discharge sustain voltage thereof are decreased.

The inventive MgO—ZrO₂ protective layer is formed with a thickness of 600 nm or more. When the protective layer has a columnar crystal structure grown in mixed directions, better capacity enhancement effect can be obtained.

### EXAMPLE 1

A liquid phase reaction technique (LPE) was used while taking Mg(OH)₂ and ZrOCl₂.8H₂O as a starting material. The mixture was weighed such that the amount of addition of ZrO₂ was 0, 1, 2, 3 and 4 mol %. The mixture was then mixed with distilled water to a concentration of 40% and ball-milled by a zirconia ball to make a slurry.

The slurry was spray-dried, and heat-treated at 1000° C. for one hour. It was then ball-milled under wet conditions by a zirconia ball of 10 mm for 12 hours.

Thereafter, the target material was again spray-dried, and uni-directionally compressed with a pressure of 2000 Pa at ambient temperature to form a pellet with a diameter of 5 mm. The pellet was sintered at 1600° C. for one hour. The sintered pellet was used as a starting material for the electron beam deposition.

Electron beam deposition equipment with an electron gun with a maximum output of 3 kW was used to deposit a MgO—ZrO₂ layer according to the invention. The voltage applied thereto was fixed to 4 kW. A MgO—ZrO₂ protective layer was deposited while varying the application current from 100 mA to 500 mA in consideration of the passage difference between the electron gun and the pellet. The deposition speed and the surface roughness of the target layer were analyzed, and the current was then fixed to 250 mA. The chamber of the electron beam deposition equipment was kept in a vacuum at between 10 and 6 Torr, and the MgO—ZrO₂ protective layer was deposited onto the respective pellets where the amount of addition of ZrO₂ was 0, 1, 2, 3 and 4 mol %, respectively.

The performance characteristics were evaluated with respect to the deposited MgO—ZrO₂ protective layer.

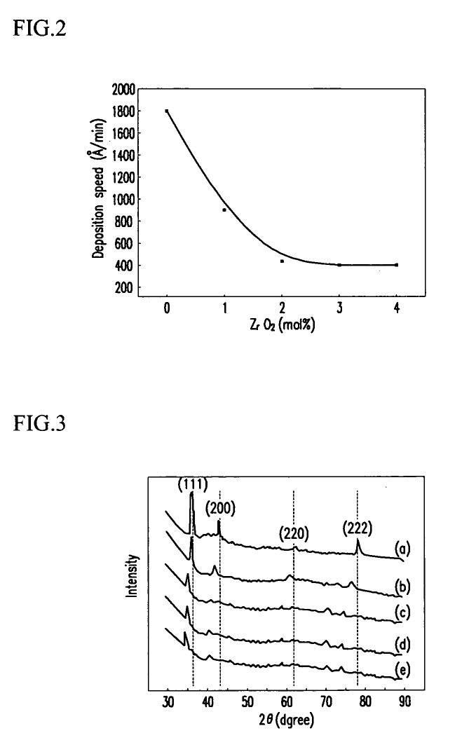

FIG. 2 is a graph illustrating the deposition speed of the MgO—ZrO₂ protective layer as a function of the amount of addition of ZrO₂. As illustrated in the graph, it was confirmed that the deposition speed of the protective layer was decreased with the addition of ZrO₂. It is believed that the deposition speed was reduced because the vapor pressure of ZrO₂ is significantly lower than that of MgO.

However, when the amount of addition of ZrO₂ exceeds 3 mol %, Zr goes over the solid solution limit, and no longer forms a solid solution with MgO. At such levels, a reduction in the deposition speed is no longer achieved. Accordingly, it is preferable that the amount of addition of ZrO₂ is 3 mol % or less due to the solid solution limit thereof.

FIG. 3 illustrates the X-ray diffraction analysis of a MgO—ZrO₂ protective layer, where (a) to (e) indicate the cases where the amount of addition of ZrO₂ was 0, 1, 2, 3 and 4 mol %, respectively.

With the X-ray diffraction analysis, Cu—Kα was used as a target, and Ni was used as a filter. The measurement was made at a speed of 2° per minute.

As shown in FIG. 3, as the amount of addition of ZrO₂ increased, the X-ray diffraction peak was shifted to the low value of 2Θ. This means that Zr with a large ion radius is solid-soluted in MgO, and the lattice constant of the MgO—ZrO₂ layer is increased.

However, where the amount of ZrO₂ exceeds 3 mol % (the peak at (d)), any shift in the peak was not observed because the Zr was over the solid solution limit.

Meanwhile, it was confirmed from the X-ray diffraction peak that when ZrO₂ was added, no problems in the crystallinity and alignment of the MgO—ZrO₂ protective layer were observed.

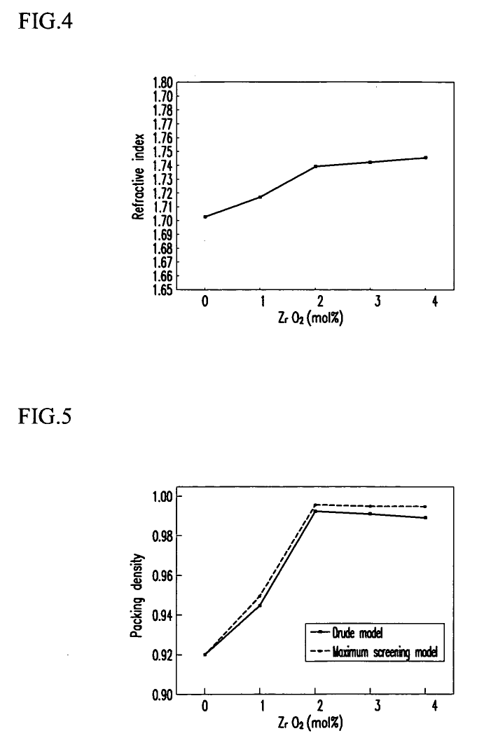

FIG. 4 is a graph illustrating the refractive index of the MgO—ZrO₂ protective layer as a function of the amount of addition of ZrO₂. As illustrated in the graph, the refractive index of the target layer increased as the amount of addition of ZrO₂ increased. Where the MgO protective layer includes ZrO₂ in an amount from 0.1 to 3 mol %, it was confirmed that the refractive index thereof was 1.74 or less.

FIG. 5 illustrates the packing density of the MgO—ZrO₂ protective layer as a function of the amount of ZrO₂ added. The packing density was measured from the Drude model and the maximum screening model.

As shown in FIG. 5, with the Drude model and the maximum screening model, it was confirmed that the packing density of the MgO—ZrO₂ protective layer was higher than that of a pure MgO layer. Accordingly, for a MgO protective layer with ZrO₂ added, the plasma corrosion resistant characteristic is enhanced, and the life span of the plasma display panel is lengthened.

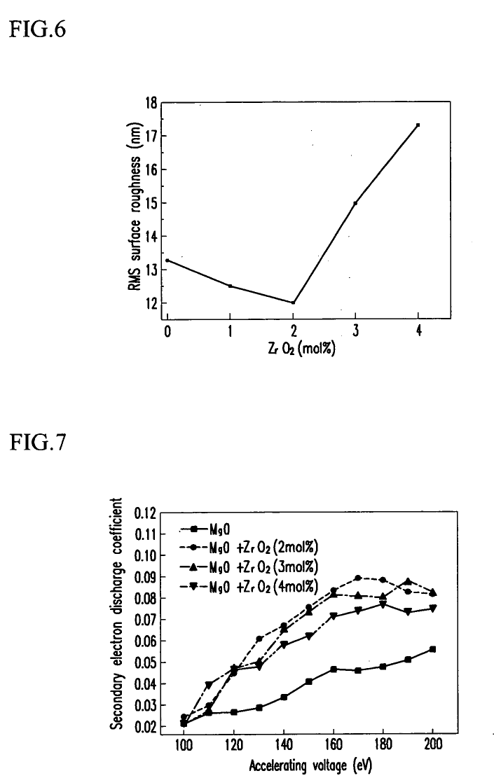

FIG. 6 is a graph illustrating the surface roughness of the MgO—ZrO₂ protective layer as a function of the amount of ZrO₂ added. The surface roughness was measured with different samples having the same composition five times, with no significant deviation. Therefore, only the mean value of the surface roughness (RMS) was indicated.

As shown in FIG. 6, the surface roughness was decreased till the amount of addition of ZrO₂ reached 2 mol %, and then, increased. Where the MgO protective layer included ZrO₂ from 0.1 to 3 mol %, the surface roughness thereof (the RMS mean value) was 15 nm or less. That is, the inventive MgO—ZrO₂ layer has an excellent surface roughness.

The transmissivity was measured using an ellipsometer (Plas Mos SD2302, German) and an ultraviolet light/visible light spectrometer. A transmissivity of 90% or more was confirmed for all cases.

FIG. 7 illustrates the secondary electron discharge coefficient as a function of the accelerating voltage based on the amount of ZrO₂ added. The accelerating voltage was 100 to 200 V, and Ne gas was used.

As shown in FIG. 7, the secondary electron discharge coefficient of the MgO—ZrO₂ protective layer was higher than that of a pure MgO layer. Particularly when the amount of addition of ZrO₂ was 2 mol %, the secondary electron discharge coefficient of the MgO—ZrO₂ protective layer was 0.024 to 0.089, which is about twice as efficient as that of pure MgO which was 0.02 to 0.045. That is, when the secondary electron discharge coefficient of the MgO—ZrO₂ protective layer is increased, the discharge voltage is decreased, thereby serving to enhance the driving and discharging characteristics at lower voltages.

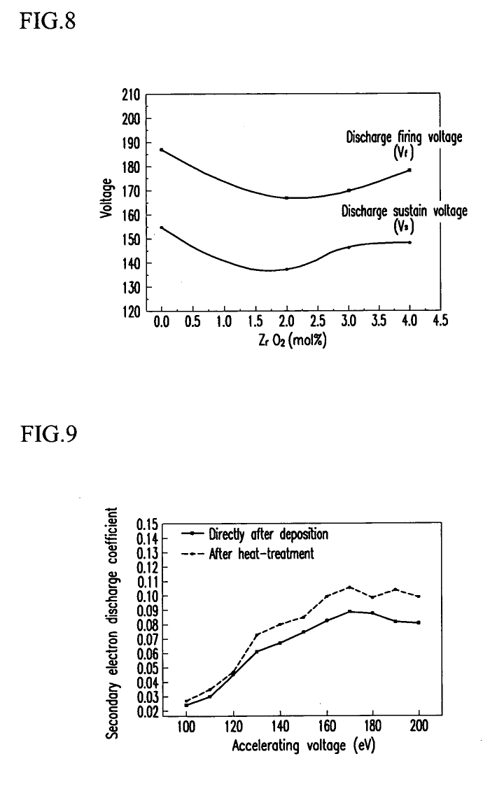

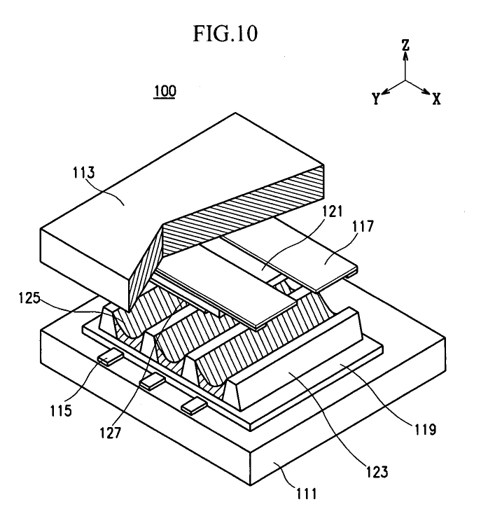

FIG. 8 illustrates the discharge firing voltage (Vf) and the discharge sustain voltage (Vs) of the MgO—ZrO₂ protective layer as a function of the amount of addition of ZrO₂. As shown in FIG. 8, the discharge firing voltage and the discharge sustain voltage of the MgO—ZrO₂ protective layer were reduced, compared to the pure MgO layer. Particularly when the amount of ZrO₂ added was 1.8 to 2.2 mol %, the discharge initiating voltage and the discharge sustain voltage of the MgO—ZrO₂ protective layer were at the lower level, and the best discharge characteristics were obtained.

Furthermore, in order to improve the moisture-resistance of the protective layer, a MgO—ZrO₂ layer including 2 mol % ZrO₂ was vacuum heat-treated at 150° C. for 30 minutes, and the secondary electron discharge coefficient was measured, followed by comparing the measurement result with that of the non-treated sample.

FIG. 9 illustrates the secondary electron discharge coefficient of the non-treated MgO—ZrO₂ protective layer with 2 mol % ZrO₂ directly after the deposition and that of the heat-treated MgO—ZrO₂ protective layer with 2 mol % ZrO₂ as a function of the accelerating voltage.

As shown in FIG. 9, when heat-treated, the secondary electron discharge coefficient of the MgO—ZrO₂ protective layer increased.

As described above, when a protective layer where MgO includes 0.1 to 2.2 mol % ZrO₂, the electron emission capacity was improved, as was the display quality of the plasma display panel.

Although preferred embodiments of the present invention have been described in detail hereinabove, it should be clearly understood that many variations and/or modifications of the basic inventive concept herein taught which may appear to those skilled in the art will still fall within the spirit and scope of the present invention, as defined in the appended claims.

1. A plasma display panel comprising:
a substrate;
a plurality of electrodes formed on the substrate;
a dielectric layer covering the plurality of electrodes; and
a protective layer covering the dielectric layers, the protective layer comprising MgO and 0.1 to 3 mol % ZrO₂.

2. The plasma display panel of claim 1 wherein the protective layer comprises 1.8 to 2.2 mol % ZrO₂.

3. The plasma display panel of claim 1 wherein the protective layer comprises a solid solution of ZrO₂ in MgO.

4. The plasma display panel of claim 1 wherein the protective layer has a transmissivity of 90% or more.

5. The plasma display panel of claim 1 wherein the protective layer has a thickness of 600 nm or more.

6. The plasma display panel of claim 1 wherein the protective layer has a refractive index of 1.45 to 1.74.

7. The plasma display panel of claim 1 wherein the protective layer has a columnar crystal structure.

8. A MgO pellet for a protective layer of a plasma display panel comprising MgO and 0.1 to 3 mol % ZrO₂.

9. The MgO pellet of claim 8 comprising 1.8 to 2.2 mol % ZrO₂.

10. The MgO pellet of claim 8 comprising a solid solution of ZrO₂ in MgO.
